(19) United States
(12) Patent Application Publication
(10) Pub. No.: US 2025/0215643 A1
(43) Pub. Date: Jul. 3, 2025

(54) COMPOSITE FIBERS AND METHODS OF MAKING THE SAME

(71) Applicant: Specialty Minerals (Michigan) Inc., Bingham Farms, MI (US)

(72) Inventors: John Hockman, Bath, PA (US); Harry J. Huhn, Bethlehem, PA (US); Ari-Pekka Laakso, Bingham Farms, MI (US); Zhigang Chen, Bingham Farms, MI (US)

(21) Appl. No.: 18/852,054

(22) PCT Filed: Mar. 27, 2023
(86) PCT No.: PCT/US2023/016399

§ 371 Date: Sep. 27, 2024

(51) Int. Cl. D21C 9/00; C01F 11/18; D21H 11/18; D21H 17/00; D21H 17/67; D21H 17/70

(52) U.S. Cl. CPC D21C 9/004; C01F 11/181; D21H 11/18; D21H 17/675; D21H 17/70; D21H 17/74

(57) ABSTRACT

A method of making a composite fiber can include admixing a calcium hydroxide slake and carbon dioxide containing gas with an aqueous slurry containing fiber, wherein the addition of the slake is controlled to maintain the conductivity below saturation to thereby produce a composite fiber with improved bulking and stiffness properties when used as a filler in papermaking.

### CROSS-REFERENCE TO RELATED APPLICATION

The benefit of priority to U.S. Provisional Patent Application No. 63/326,240 filed Mar. 31, 2022, is hereby claimed and the disclosure is incorporated herein by reference in its entirety.

### FIELD

The disclosure relates to composite fibers and method for making composite fibers and more particularly to mineralized nanocellulose with calcium carbonate and methods of precipitating calcium carbonate for attachment onto nanocellulose.

### BACKGROUND

Various techniques are known in the art for precipitation of calcium carbonate. Precipitated calcium carbonate (PCC) is used in various papermaking manufactures of fine papers like copy paper, mechanical grade papers like SC, container, and carton board. Various forms of precipitated calcium carbonate and cellulose-calcium composite materials have been used in the paper industry as filler material. Conventional cellulose-calcium carbonate materials incorporate the calcium carbonate such that the essential fibrous nature of the cellulose component is maintained. It was generally recognized in the art that the fibrous nature of the composite materials was needed to better incorporate the composite materials in the fiber matrix of paper.

U.S. Pat. No. 9,150,738 teaches an inverse carbonation process for forming various crystal forms of precipitated calcium carbonate. The inverse carbonate process has been found to be beneficial for particularly targeting scalenohedral morphology. The '738 patent teaches a key feature is initial addition of carbon dioxide into a reaction vessel until a controlled pH of 5-7 is obtained. After such pH control, the calcium hydroxide slurry is added at a rate such that a target conductivity is achieved to thereby precipitate the calcium carbonate.

WO 97/01670 teaches porous aggregates of calcium carbonate particles precipitated on the surface of cellulose fibers. EP 0 930 345 and EP 0 935 020 teach similar fillers, but without precipitation of the calcium carbonate on the surface of the fibers, but rather mixed with them. U.S. Pat. No. 10,683,616 teaches a method of producing a composite that introduces microfibrillated cellulose during the calcium carbonate precipitation process after a portion of the calcium hydroxide has been reacted with the carbon dioxide.

Surface mineralized fibers are also known, such as disclosed in WO2021/252572. Such fibers are generally produced using sodium carbonate for carbonation and have low fiber attachment amounts.

### SUMMARY

A need remains in the art for improved filler materials. Fibers produced in accordance with methods of the disclosure have significant improvements in mineral attachment. For various applications, the mineral can beneficially be provided as long chains of scalenohedral PCC attached to the nanocellulose fiber for improved properties.

A filler in accordance with the disclosure can include composite fibers, each composite fiber comprising mineral attached to a fiber, wherein the mineral is at least about 90 wt % based on the total weight of the composite fiber, the uncoated fiber has an average length of less than 300 μm, and the composite fiber has a Horiba d90 of at least 10 μm. For example, the fiber can be nanocellulose and the mineral can be calcium carbonate.

A method of making composite fibers in accordance with the disclosure can include preparing a calcium hydroxide slake by diluting lime in water; admixing an aqueous fiber slurry with dilution water in a reactor; adding the calcium hydroxide slake and a CO₂ containing gas into the reactor containing the aqueous fiber slurry admixed with the dilution water to precipitate calcium carbonate onto the fiber; and continuing a flow of the CO₂ containing gas into the admixture after the addition of the calcium hydroxide slake has started until a pH of 7.0 is reached. The calcium hydroxide slake is added at a rate to maintain a target conductivity that is 50% to 80% of saturation and the target conductivity is maintained until the addition of the calcium hydroxide slake is complete, the fiber slurry comprises fibers having a length of 300 μm or less, and the fiber slurry comprises an amount of fiber such that fiber content in the composite fibers is 10 wt % or less based on the total weight of the composite fibers. The calcium hydroxide slake can be added concurrently, before, or after the start of CO₂ addition.

### BRIEF DESCRIPTION OF THE DRAWINGS

FIGS. 1A and 1B are scanning electron microscopy (SEM) images of composite fibers in accordance with the disclosure.

FIG. 2 is a graph showing pH, conductivity, temperature, and gas flow as a function of time for a process in accordance with the disclosure.

FIGS. 3A and 3B are SEM images of conventional fiber-containing precipitated calcium carbonate (PCC).

FIG. 4A is a graph showing comparative bulking properties of handsheets made with composite fiber filler in accordance with the disclosure, precipitated calcium carbonate with no nanocellulose, or PCC with nanocellulose added to furnish.

FIG. 4B is a graph showing comparative breaking length of handsheets made with composite fiber filler in accordance with the disclosure, precipitated calcium carbonate with no nanocellulose, and PCC with nanocellulose added to furnish.

FIG. 4C is a graph showing comparative bending resistance indices of handsheets made with composite fiber filler in accordance with the disclosure, precipitated calcium carbonate with no nanocellulose, or PCC with nanocellulose added to furnish.

FIGS. 5A and 5B are SEM images of composite fibers in accordance with the disclosure.

FIGS. 5C and 5D are SEM images of calcium carbonate precipitated using a reverse carbonation process with 50% saturation, but without the presence of fiber.

FIG. 6 is SEM images of precipitated calcium carbonate without fiber, produced at 50% saturation with a starting carbonation temperature of 42° C.

FIG. 7 is SEM images of composite fibers in accordance with the disclosure produced using 50% saturation, with 0.5 wt % fiber and a starting carbonation temperature of 39° C.,

FIG. 8 is SEM images of composite fibers in accordance with the disclosure produced using 50% saturation, with 0.5 wt % fiber and a starting carbonation temperature of 11° C.

FIG. 9 is SEM images of composite fibers in accordance with the disclosure produced using 50% saturation, with 0.5 wt % fiber and a starting carbonation temperature of 26.5° C.

FIG. 10 is SEM images of composite fibers produced using 70% saturation, with 0.5 wt % fiber and a starting carbonation temperature of 26.5° C.

### DETAILED DESCRIPTION

Composite fibers and methods of the disclosure unexpectedly and beneficially provide improved bulking and strength properties when used as fillers in making paper products. Typically, it was expected that high strength fillers densify the paper sheet, disadvantageously affecting the stiffness of the sheets. It was surprisingly found that the composite fibers of the disclosure can improve both bulk and strength resulting in improved stiffness. Additionally, methods of the disclosure can beneficially result in significant improvements in the percent of attached mineral. Still further, methods of the disclosure can allow for control over the mineral morphology and can beneficially provide composite fibers where all or substantially all of the mineral is present in a desired morphology, such as a scalenohedral morphology.

For example, the composite fibers of the disclosure can have long chains of scalenohedral mineral, for example, scalenohedral calcium carbonate, attached to the fiber template, which can advantageously result in the composite fibers maintaining fiber like qualities when used as fillers in papermaking.

Composite fibers of the disclosure when used as fillers in papermaking can provide high bulk and stiffness, as well as good natural retention and drainage while imparting increased physical strength. The process of the disclosure results in significantly more surface coverage of the fiber with all or substantially all of the precipitated mineral being attached to the fiber.

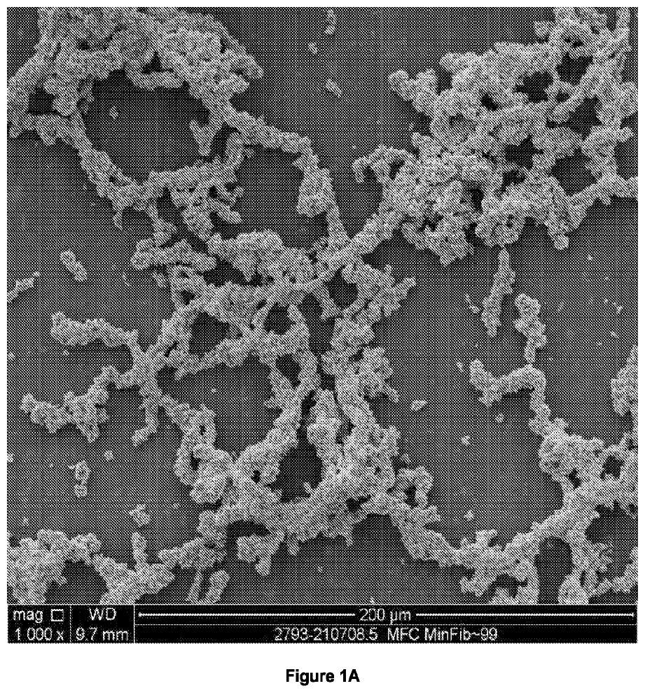

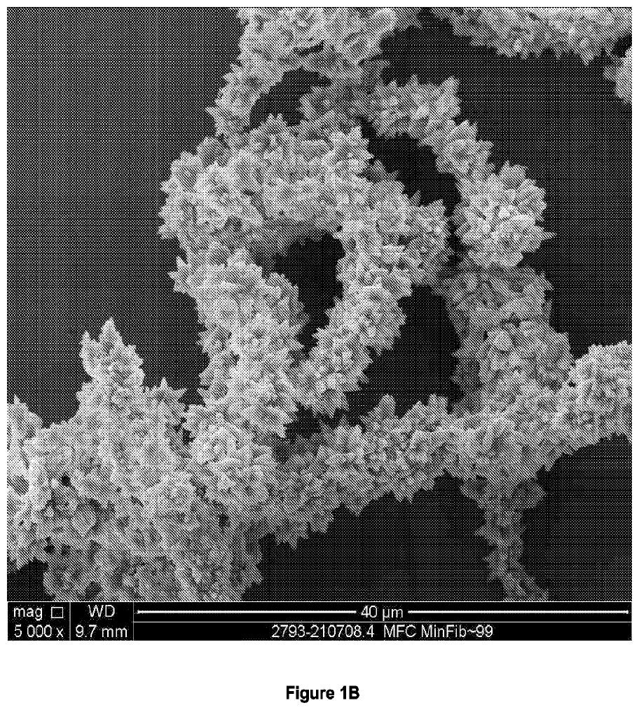

Composite fibers in accordance with the disclosure include a fiber and the mineral attached thereto. For example, the mineral can be in the form of long chains that attach to and surround the fiber, thereby coating the fiber, such as shown in FIG. 1. The composite fiber has at least 90 wt % mineral based on the total weight of the fiber. For example, the composite fiber can have about 0.5 wt % to about 10 wt % fiber based on the total weight of the composite fiber. There must be a sufficient amount of fiber to direct precipitation of all or substantially all of the mineral onto the fiber. It has been found that amounts of fiber less than 0.5 wt % result in too much unattached mineral. Amounts of fiber above 10 wt %, however, have been found to disadvantageously affect the ability of the mineral to grow into scalenohedrals and instead result in rhombic or cubic morphology.

Composite fibers in accordance with the disclosure advantageously exhibit fibrous-like properties when included as a filler. Composite fibers in accordance with the disclosure have a Horiba doo of at least about 10 μm, at least about 20 μm at least about 25 μm, at least about 30 μm, at least about 40 μm, or at least about 50 μm.

The fiber can be nanocellulose. The nanocellulose is a cellulosic material having at least one dimension such as fibril particle diameters or width on the order of nanometers, for example, 100 nm or less. The fibers have a length of 300 μm or less. For example, the fibers before coating with the mineral can have a length of about 100 μm to about 300 μm. For example, the fibers can have a length of about 200 μm. Any nano-structured cellulose can be used as the fiber.

A method of forming a composite fiber in accordance with the disclosure includes forming an aqueous slurry containing the fiber. The amount of fiber in the aqueous slurry is selected such that the fiber is present in the composite fiber in an amount of about 0.1 wt % to about 10 wt %, about 0.25 wt to about 5 wt %, about 0.5 wt % to about 8 wt %, about 0.25 wt % to about 1 wt % based on the total weight of the composite fiber. For example, the fiber can be present in an amount, based on the total weight of the composite fiber, of about 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.5, 2, 2.5, 3, 3.5, 4, 4.5, 5, 5.5, 6, 6.5, 7, 7.5, 8, 8.5, 9, 9.5, 10 wt %, or any ranges defined by such values. The slurry can have a solids content of about 0.1% to about 3%, about 0.1% to about 1%, about 0.5% to about 1.5%, about 0.1% to about 6%. Other suitable solids contents include 0.1, 0.2, 0.3, 0.4, 0.5, 0.6, 0.7, 0.8, 0.9, 1, 1.2, 1.4, 1.6, 1.8, 2, 2.2, 2.4, 2.6, 2.8, 3, or any ranges defined by such values. The aqueous fiber slurry is added to the reactor as the heel.

A mineral slake can be prepared by mixing a suitable mineral containing material with water. For example, the mineral slake can be a calcium hydroxide slake. The calcium hydroxide slake is prepared by mixing lime and water. The water to lime ratio can be about 4:1 to about 15:1, about 5:1 to about 10:1, or about 5:1 to about 7:1. For example, the water to lime ratio can be 7:1. The lime and water can be mixed to form the slake. In various embodiments control of the initial temperature of the water is not necessary and can be dependent on process water in the plant. For example, the initial water temperature can be 32° C. Once mixed, the slake can optionally be screened to remove larger grit particles. For example, the slake can be screened through a 30 mesh screen, a 60 mesh screen or a 200 mesh screen.

The heel can be mixed in reactor and then the slake and a gas containing CO₂ can be added to precipitate the mineral onto the fiber present in the heel. The initial reactor temperature can be, about 1° C. to about 50° C., about 11° C. to about 45° C., or about 35° C. to about 50° C., but need not be controlled during the process.

For example, the slake can be added and then CO₂ containing gas can be flowed. Alternatively, the CO₂ containing gas can be flowed and then slake can be added shortly thereafter. For example, the two components can be added in either order within seconds of one another, for example within 10 seconds.

Methods of the disclosure utilize reverse addition where the calcium hydroxide slake is metered into the aqueous fiber containing heel with control over the addition rate to limit the conductivity to be about 50% to 80% of saturation. The calcium hydroxide slake addition rate is controlled throughout the precipitation process to maintain the target conductivity. As used herein, “saturation” refers the conductivity of the starting calcium hydroxide slurry of fully saturated form. A conductivity of about 70% of saturation refers to a conductivity that is less than 70% of the conductivity of the starting calcium hydroxide slurry. Control over the conductivity can be achieved within about 1% of the reaction being complete. The target conductivity can be for example 50% of saturation, 60% of saturation, 70% of saturation, or 80% of saturation. For example, target conductivity can be 50% of saturation. Actual conductivity values can vary depending on the conductivity of the starting slake and the reactor. However, the actual conductivity values for controlling the reaction to be 70% of saturation can readily be determined by measuring the conductivity of the slake prior to addition and setting the conductivity to less than 70% of the measured value. For example, 50% of saturation can be maintained at conductivity values of about 3000 μs/cm to 5500 μs/cm depending on the starting conductivity of the slake as illustrated in the various examples.

It has been found that the pH need not be strictly controlled during the precipitation process. Once all slake has been added, the flow of the CO₂ containing gas can be continued until the pH reaches 7.0.

The CO₂ containing gas can be, for example, a blend of CO₂ and air. For example, the gas or blended gas can include about 5% CO₂ to about 100% CO₂.

The process of the disclosure results in composite fibers in a slurry. The slurry cannot be screened due to the fibrous nature of the resulting composite fibers. The slurry can be used as is, for example, as a filler in papermaking. Alternatively, the composite fiber slurry can be dried to provide a dried product, which can be used for other applications.

### EXAMPLES

### Example 1

A mineralized nanocellulose fiber was prepared in accordance with the method of the disclosure. A calcium hydroxide slake was prepared by mixing water and lime at a mass ratio of 7:1. In particular, 357 g lime were mixed with 2500 ml water. The water had a starting temperature of 32° C. The lime was added to the water while mixing at 750 rpm and mixing was continued for 15 min. The resulting slurry was screened through a No. 200 mesh screen to remove +200 mesh grit.

147.48 g of nanocellulose having a solids content of 0.5% was diluted in 800 ml water to form a slurry having a solids content of 0.5% 8% solids. The target PCC % in the PCC/fiber composition was 99. Nanocellulose template addition was calculated to be 1 wt % of the final product weight. The nanocellulose was added to the reactor first as the carbonator heel and mixed at 1250 rpm. The initial temperature was 40.8° C. CO₂ gas was flowed into the reactor with a flow set-points of 0.76 sim CO₂ and 3.1 slm air. Within 10 seconds, the calcium hydroxide slake was then added to the carbonator heel pumping at a rate of 14 ml/min over 120 min. The slake addition rate was adjusted to maintain conductivity of 4.5-5.0 ms/cm, which was 50% of the conductivity of the starting slake. Once all of the slake was added, CO₂ addition was continued to an endpoint reaction to pH 7.0. The resulting product could not be screened 325 mesh due to the fibrous nature. FIG. 1 is an SEM image of the resulting composite fiber.

The resulting product was characterized for Horiba Particle Size and BET surface area. The characterization is shown in Table 1:

| | |
|---|---|
| PCC Content (%) | 95.3% |
| Horiba d₉₀ (microns) | 12.00 |
| Horiba d₅₀ (microns) | 6.12 |
| Horiba d₁₀ (microns) | 2.72 |
| (d₉₀-d₁₀)/d₅₀ | 1.5 |
| BET Surface Area (m²/g) | 5.3 |

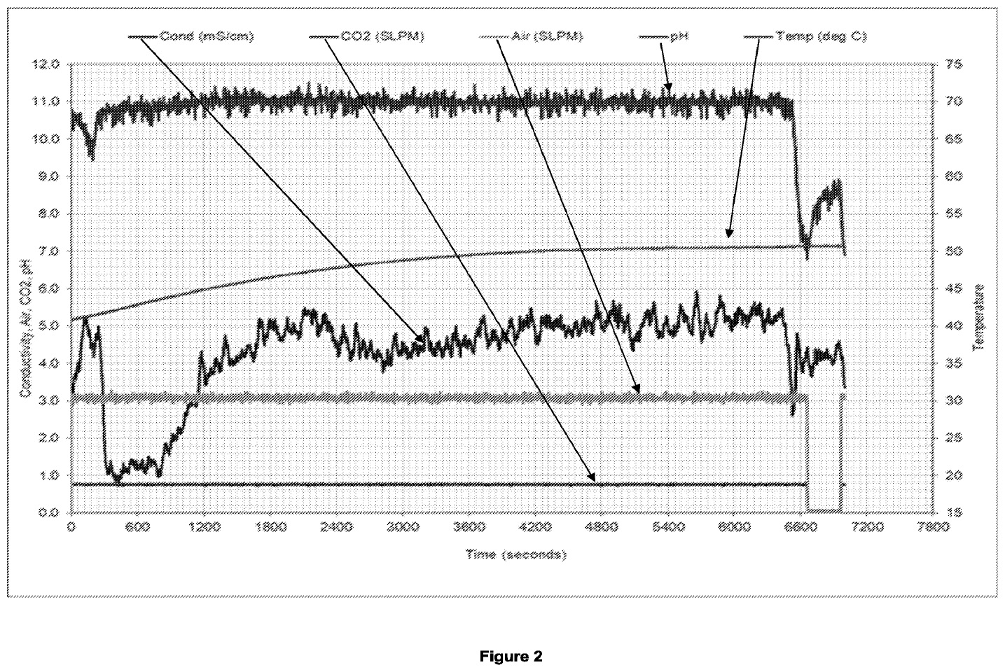

FIG. 2 is a graph of pH, conductivity, and temperature trends in the reaction. It was found that pH at saturation was not a key parameter for controlling the process.

### Example 2

A composite fiber was produced in accordance with the method described in Example 1, except the CO₂ addition was started after starting the addition of the calcium hydroxide slake. It was found that the order of addition of the CO₂ addition and slake did not impact the composite fiber features and significantly, control over pH prior to calcium hydroxide slake was not needed to obtain good fiber properties. The table below provides a comparison of fiber properties made in accordance with Example 1 (CO₂ addition before slake) and the present Example 2 (CO₂ addition after slake addition). Both examples were produced maintain 50% saturation in the heel within 1% of the total reaction time.

| | CO₂ before Slake | Slake Before CO₂ |
|---|---|---|
| PCC content (%) | 95.1 | 95.2 |
| Horiba d₉₀ (μm) | 11.99 | 11.96 |
| Horiba d₅₀ (μm) | 6.14 | 6.43 |
| Horiba d₂₀ (μm) | 3.78 | 4.04 |
| Horiba d₁₀ (μm) | 2.83 | 2.99 |
| (d₉₀-d_{d10})/d₅₀ | 1.49 | 1.40 |
| SSA (m₂/g) | 3.8 | 2.6 |

### Example 3

Composite fibers produced in accordance with Example 1 was tested in the production of a copy paper hand-sheet. The composite fiber of the disclosure was compared to standard precipitated calcium carbonate, and a method in which nanocellulose was added to furnish.

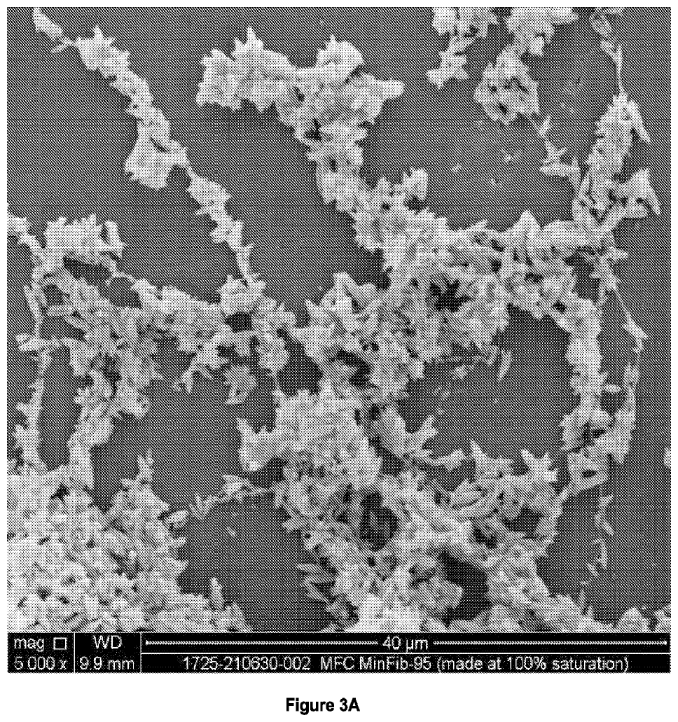

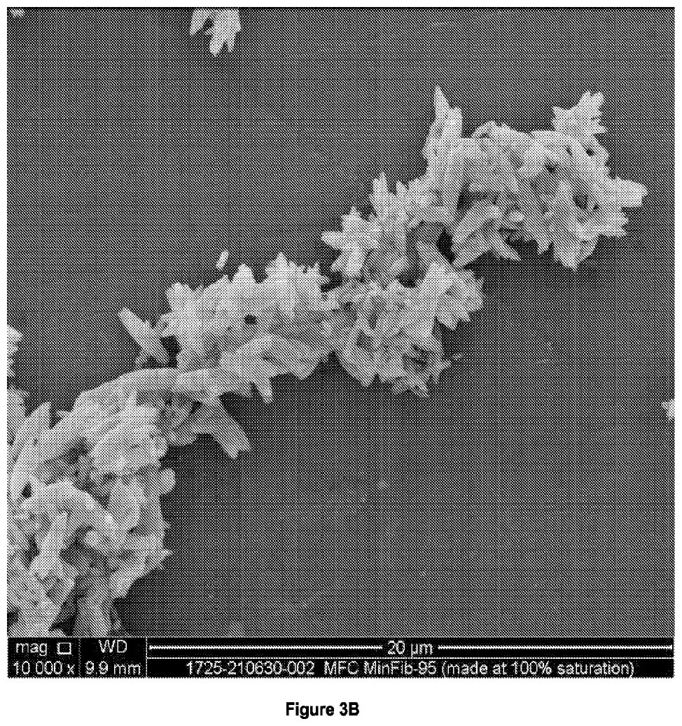

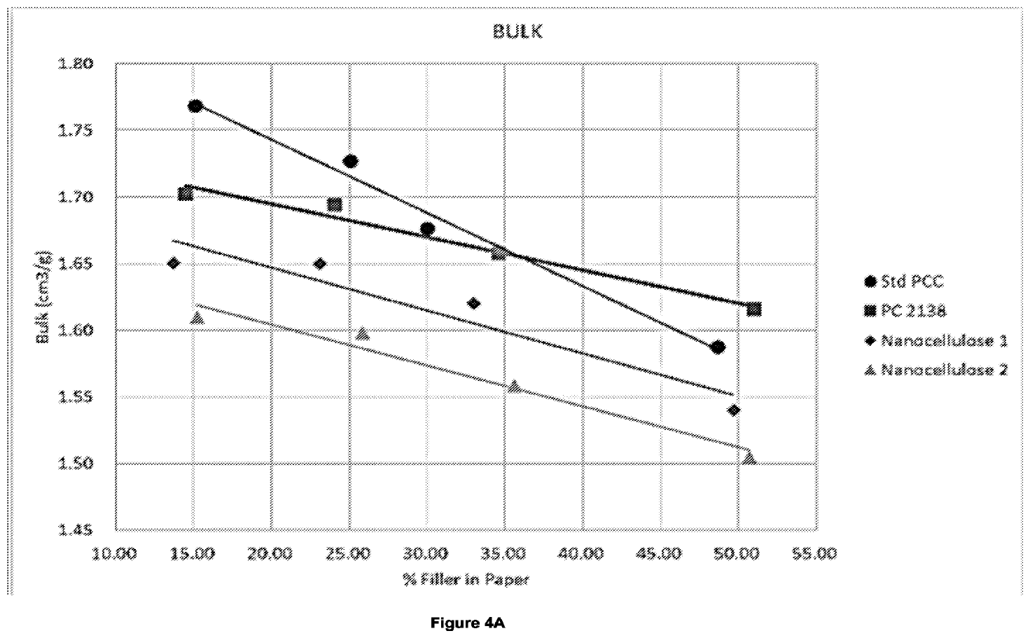

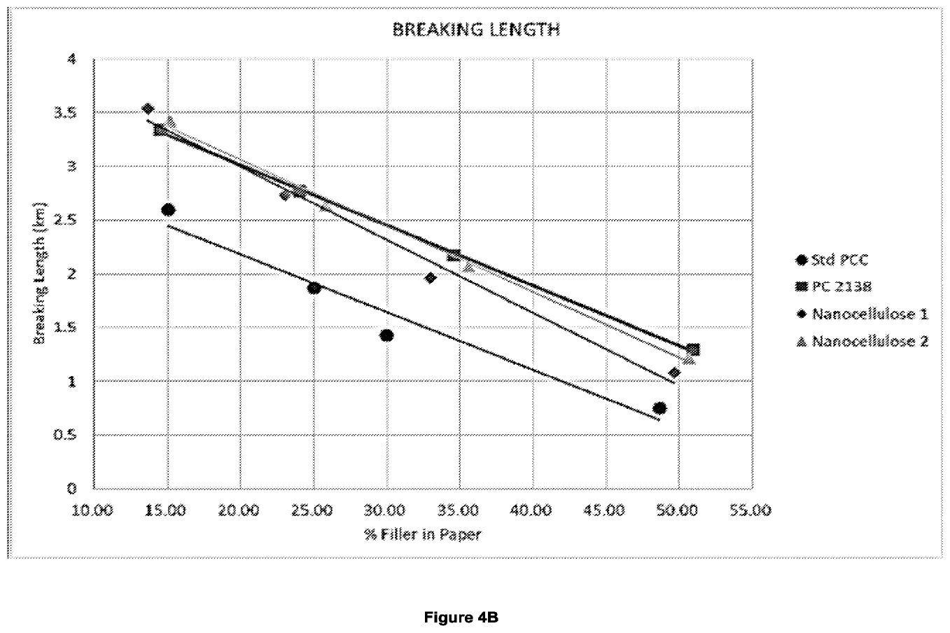

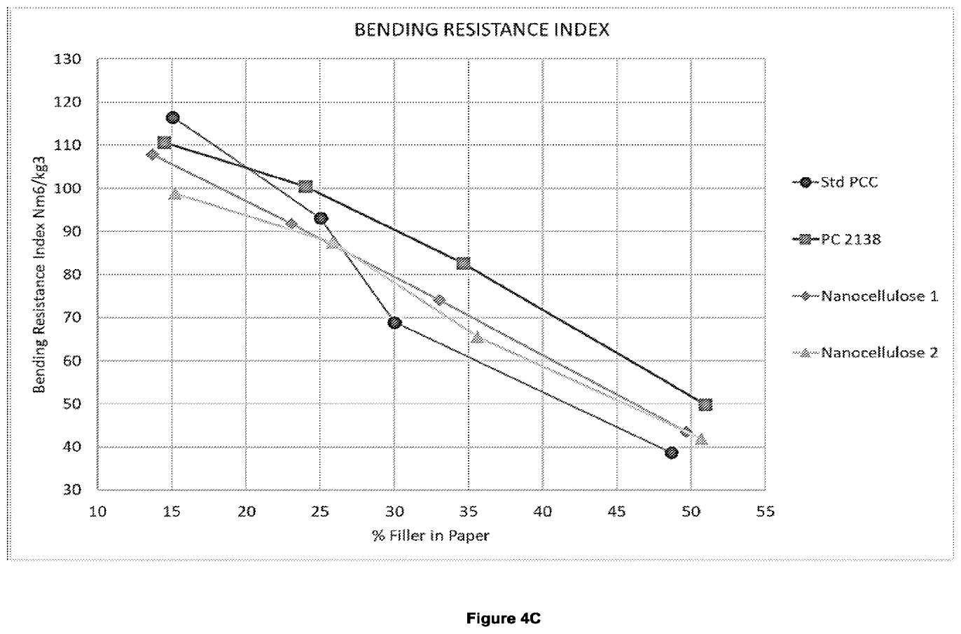

The conventional nanocellulose containing precipitated calcium carbonate was formed by adding nanocellulose as a precursor additive to the calcium hydroxide slurry prior to passing CO₂ gas through it to precipitate calcium carbonate at 100% saturation. Referring to FIG. 3, the conventional nanocellulose containing PCC showed less attachment and a very different morphology as compared to the composite fiber of the disclosure. As shown in the table below, there were significant differences in the particle size distributions of the conventional nanocellulose PCC and the composite of the disclosure, particularly in the d90 and d50, indicating that there was less fibrous material in the conventional nanocellulose PCC. The conventional nanocellulose PCC exhibited loosely strung single scalenohedral morphology. In FIG. 4, Nanocellulose 1 and Nanocellulose 2 refer to samples that were prepared using the same method of the disclosure, but with different fiber species that had similar particle sizes. It was found that this morphology was more sensitive to shear forces of the paper machine.

| | Composite Fiber of the | Nanocellulose added to |
|---|---|---|
| | Disclosure (50% | Slake (100% saturation |
| | saturation addition) | addition) |
| PCC content (%) | 95.3 | 96.1 |
| Horiba d₉₀ (μm) | 11.96 | 5.71 |
| Horiba d₅₀ (μm) | 6.43 | 2.36 |
| Horiba d₁₀ (μm) | 2.99 | 0.92 |
| (d₉₀-d₁₀)/d₅₀ | 1.4 | 2.03 |
| SSA (m₂/g) | 2.6 | 6.9 |

The copy paper handsheets were prepared with eucalyptus pulp refined to 400 Canadian Standard Freeness. The handsheets were produced at a target basis weight of 80 gsm. Filler amounts were adjusted to achieve a target level of 15, 25, 35, or 50%. The additives were added, as follows: cationic starch (Stalok 310) at 3 kg/tonne of paper, filler at target level, retention aid (Percol 175) at 0.01 kg/tonne of papers. All chemicals were added on a dry-on-dry basis. The handsheets were formed on a Formax (Nobel and Wood) sheet former. They were pressed at 4 psi while the sheet was still on the forming wire sandwiched between pieces of paper machine felt material. The handsheets were then removed from the forming wire and sandwiched between two pieces of unsized blotting paper and pressed at 25 psi. The handsheets were then dried for 1 min at 125° C. on a drum dryer. Finally, the handsheets were conditioned at 23° C. and 50% relative humidity.

The composite fiber of the disclosure demonstrated an unexpected improvement in both bulking properties and strength. Referring to FIG. 4A, the handsheets produced with the composite fiber of the disclosure demonstrated significant improvement in bulking as compared to those produced using the conventional nanocellulose (nanocellulose 1 and nanocellulose 2 in FIG. 4A). Referring to FIGS. 4B and 4C, the handsheets produced using the composite fiber also demonstrated improved strength as compared to those produced with the standard PCC, as well as improved bending resistance as compared to handsheets produced with either the standard PCC or the conventional nanocellulose.

### Example 4

To analyze the performance benefit imparted by the presence of the fiber, composite fibers were made in accordance with the method described in Example 1 (maintaining 50% saturation) and compared to precipitated calcium carbonate generated using the same method except no fiber was present in the heel. The properties of the resulting calcium carbonate produced with and without fiber are shown in the table below:

| | Composite Fiber of the | Precipitated Calcium |
|---|---|---|
| | Disclosure (with | Carbonate (without |
| | Nanocellulose and 50% | Nanocellulose 50% |
| | saturation) | saturation) |
| PCC content (%) | 95.4 | 100 |
| Horiba d₉₀ (μm) | 11.96 | 13.10 |
| Horiba d₅₀ (μm) | 6.43 | 7.74 |
| Horiba d₂₀ (μm) | 4.06 | 5.01 |
| Horiba d₁₀ (μm) | 2.99 | 3.60 |
| SSA (m₂/g) | 2.6 | 1.7 |

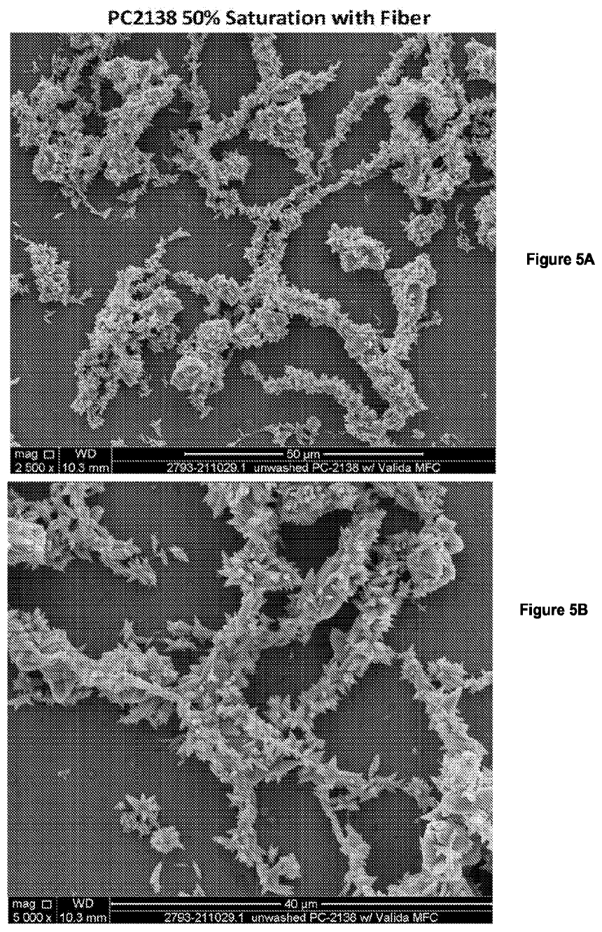

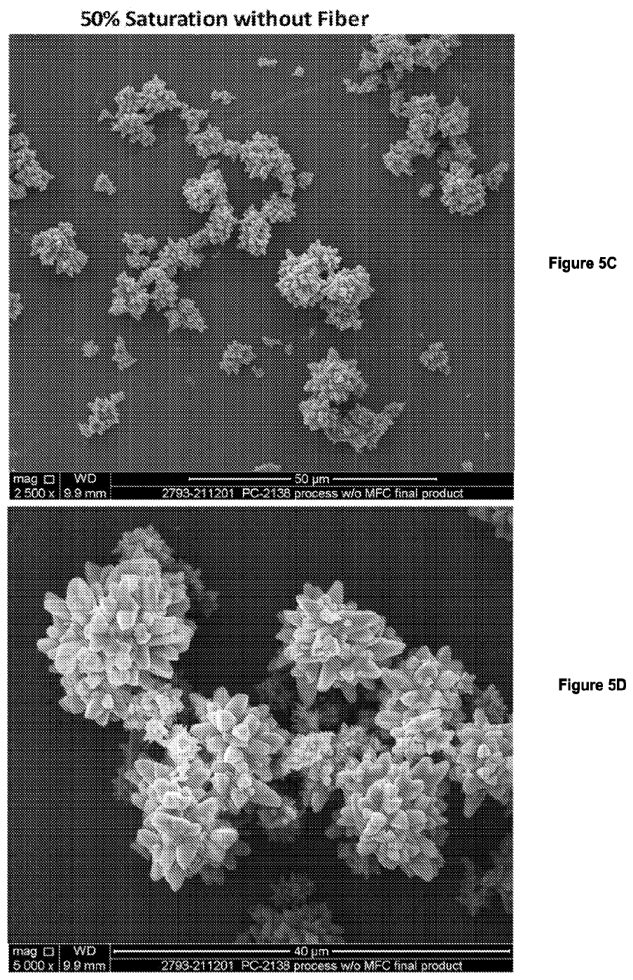

It was found that without the nanocellulose present, the precipitated calcium carbonate was in the form of non-fibrous large calcium carbonate structures, such as shown in FIGS. 5C and 5D. By comparison, the fibrous nature of the composite fibers of the disclosure can be seen in FIGS. 5A and 5B. The calcium carbonate produced without fiber did not scatter light as well, given the large structure. Without intending to be bound by theory, it is believed that the calcium carbonate produced without fiber will densify a paper sheet, resulting in less bulk and stiffness. Further, without intending to be bound by theory, it is believed that the non-fiber calcium carbonate does not retain well in the sheet due to its low specific surface area and non-acicular nature.

### Example 5

Large scale production of composites in accordance with the disclosure was produced using nanocellulose produced at the University of Maine. The nanocellulose had an average fiber length of 224 μm, a fiber width of 21.9 μm. The product had 74.7% fines, a Kink Index of 1.2, a Kink angle of 13.96, and a mean curl of 0.114.

The slake was prepared by diluting lime to a target slake solids of 15-17% and prepared by screening through a 60 mesh screen, and then drained to 470 gallons. The slake was held at about 50-55° C. using heating coils in a slake holding tank.

Water was added to the reactor and heated to the target starting temperature if needed. The starting temperature was 11° C., 25° C. or 40° C. Once the target starting temperature was reached, the water was drained to 202 gallons as the target starting volume. The water was agitated at half speed and Aqua nanocellulose was added at an addition amount of 0.5 wt % dry nanocellulose on a dry total final product weight based on the slake volume and slake concentration (MO). The agitation was then turned up to full speed and the aqueous fiber containing heel was mixed for 5 minutes.

CO₂ containing gas was flowed into the reactor as a blend of CO₂ and air at target flow rates specified in the table below. Once the gases reach their full flow rates, the slake addition was pumped into the reactor from the slake holding tank using a Moyno pump. The slake was added at a rate to maintain about 50% saturation, which was a conductivity value of 3.0-3.5 ms/cm, or about 70% saturation, which was conductivity value of 4.0-4.5 ms/cm. Once all of the slake was added, the reaction mixture was gassed until reaching pH 7.0. 1-liter and 5 gallon samples were collected for characterization.

A comparative sample in which no fiber was added was also produced using the same procedure except no fiber was added to the aqueous heel. The conditions tested and resulting calcium carbonate properties are shown in the table below.

| | | | | | |
|---|---|---|---|---|---|
| | | Ti = 40° C., | Ti < 15° C., | Ti = 25° C., | Ti = 25° C., |
| | Ti = 40° C., no | 0.5% MFC, | 0.5% MFC, | 0.5% MFC, | 0.5% MFC, |
| | MFC, 50% | 50% | 50% | 50% | 70% |
| Target conditions | saturation | saturation | saturation | saturation | saturation |

SLAKING

| | | | | | |
|---|---|---|---|---|---|
| Lime source | Mississippi | Mississippi | Mississippi | Mississippi | Mississippi |
| Feeder percent (%) | 55 | 55 | 52 | 55 | 55 |
| Zone #1 Temperature Set Point | 68 | 68 | 68 | 68 | 68 |
| (° C.) | | | | | |
| Zone #2 Temperature Set Point | 52 | 52 | 55 | 52 | 52 |
| (° C.) | | | | | |
| Rapid (ml) | — | 266 | 31.0 | 25.0 | 23.3 |
| M.O. (ml) | 32.0 | 29.1 | 34.0 | 26.8 | 25.2 |
| Rapid percent (%) | — | 91.4 | 91.2 | 93.3 | 92.5 |
| Gallons of Slake Collected (gal) | 396 | 467 | 432 | 459 | 420 |
| Gallons of Dilution Water (gal) | 130 | 99 | 180 | 53 | 0 |
| Final Rapid (ml) | 21.9 | 21.5 | 20.7 | 22.7 | 23.3 |
| Final M.O. (ml) | 24.4 | 24.1 | 23.5 | 23.7 | 25.2 |
| Slake Viscosity @ 20 RPM (cps) | 76 | 38 | 38 | | 68 |
| Final Slake Volume (gal) | 526 | 566 | 612 | 512 | 420 |

CARBONATION

| | | | | | |
|---|---|---|---|---|---|
| Theoretical Batch Time (min) | 120 | 120 | 120 | 120 | 120 |
| Theoretical CO₂ Efficiency (%) | 100 | 70 | 70 | 70 | 70 |
| CO₂ Concentration (%) | 20 | 20 | 20 | 20 | 20 |
| CO₂ Set Point (scfm) | 23 | 43 | 42 | 43 | 41 |
| Air Set Point (scfm) | 92 | 173 | 169 | 172 | 162 |
| Total Gas (scfm) | 115 | 216 | 211 | 215 | 203 |
| Agitation Speed (rpm) | 200 | 200 | 200 | 200 | 200 |
| Starting Water Heel Volume (gal) | 202 | 202 | 202 | 202 | 202 |
| MFC Addition Level (%) | 0 | 0.5 | 0.5 | 0.5 | 0.5 |
| MFC Weight addded (lbs) | 0 | 164 | 160 | 161 | 153 |
| Starting Temperature (° C.) | 41.9 | 39.0 | 11.0 | 26.5 | 26.5 |
| Starting Slake Addition Rate | 2.9 | 2.0 | 1.9 | 1.9 | 1.8 |
| (gal/min) | | | | | |
| Saturation Point (%) | 50 | 50 | 50 | 50 | 70 |
| Conductivity Range During Carb | 3-3.5 | 3-3.5 | 3-3.5 | 3-3.5 | 4-4.5 |
| (ms/cm) | | | | | |
| Slake Volume Added (gal) | 350 | 470 | 470 | 470 | 420 |
| Slake Addition Time (min) | 178 | 181.5 | 181 | 177 | 183 |
| Total Gassing Time (min) | 181 | 193 | 190 | 184 | 191 |
| Batch Efficiency (%) | 66.3 | 43.5 | 44.2 | 45.7 | 44.0 |
| Final Temperature (° C.) | 63.7 | 61.5 | 61.3 | 67.7 | 64.5 |
| End point (pH) | 6.8 | 7.2 | 6.8 | 6.9 | 6.9 |

PRODUCT

| | | | | | |
|---|---|---|---|---|---|
| Solids (%) | 15.68 | 16.45 | 15.84 | 16.57 | 16.75 |
| Viscosity @ 20 rpm (cps) | 12 | 77 | 74 | 116 | 54 |
| Horiba PSD@95% (μm) | 17.20 | 137.82 | 90.28 | 137.54 | 72.20 |
| Horiba PSD@90% (μm) | 15.01 | 51.56 | 33.59 | 56.54 | 17.45 |
| Horiba PSD@50% (μm) | 8.82 | 6.87 | 6.38 | 7.12 | 6.83 |
| Horiba PSD@20% (μm) | 5.59 | 4.15 | 3.74 | 4.2 | 4.27 |
| Horiba PSD@10% (μm) | 3.95 | 3.06 | 2.69 | 3.06 | 3.16 |
| Surface Area (m²/g) | 1.6 | 2.0 | 2.4 | 1.9 | 2.6 |
| PSD width (d₉₀-d₁₀/d₅₀) | 1.3 | 7.1 | 4.8 | 7.5 | 2.1 |
| PSD@50% mode 1 (μm) | Unimodal | 6.47 | 6.03 | 6.66 | 6.65 |
| Horiba mode 1% of distribution | — | 85% | 85% | 85% | 88% |
| PSD@50% mode 2 (μm) | — | 130.51 | 85.93 | 125.51 | 94.70 |
| Horiba mode 2% of distribution | — | 11% | 11% | 11% | 8% |

CONCLUSION

| | | |
|---|---|---|
| Colder start | Start temp. | Running at |
| temp = | 26.5° C. | 70% |
| smaller size | yielded | saturation |
| coarse | similar result | yielded |
| mode and | to start temp | significantly |
| slightly | 40° C. | narrower |
| higher SSA | | PSD and |
| | | higher |
| | | SSA; batch |
| | | efficiency |
| | | was not |
| | | improved |

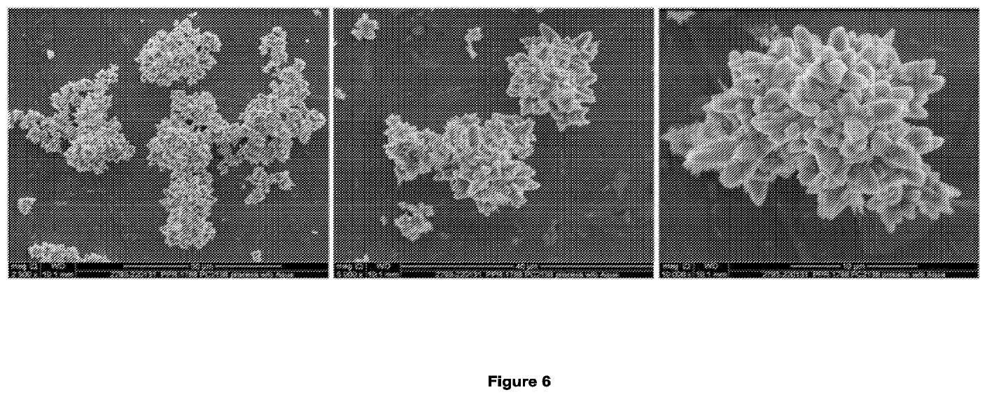

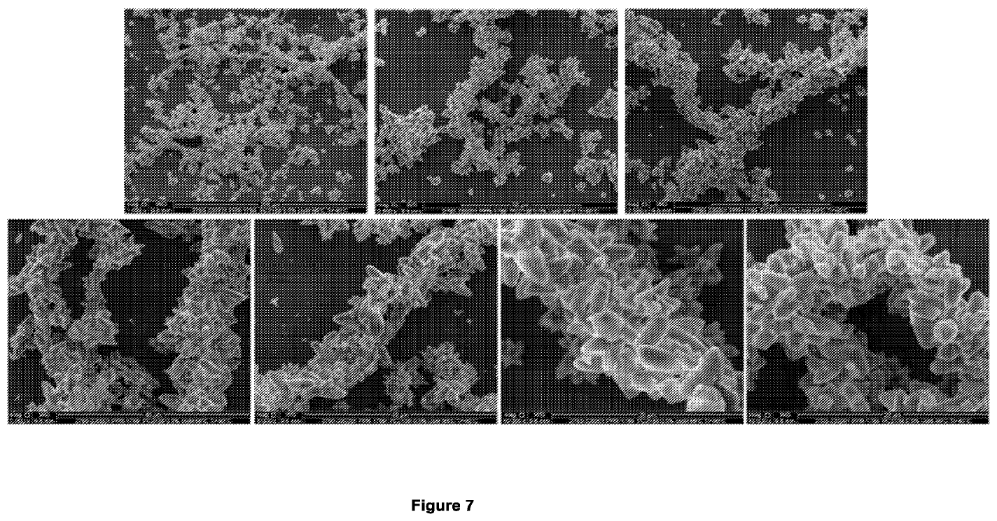

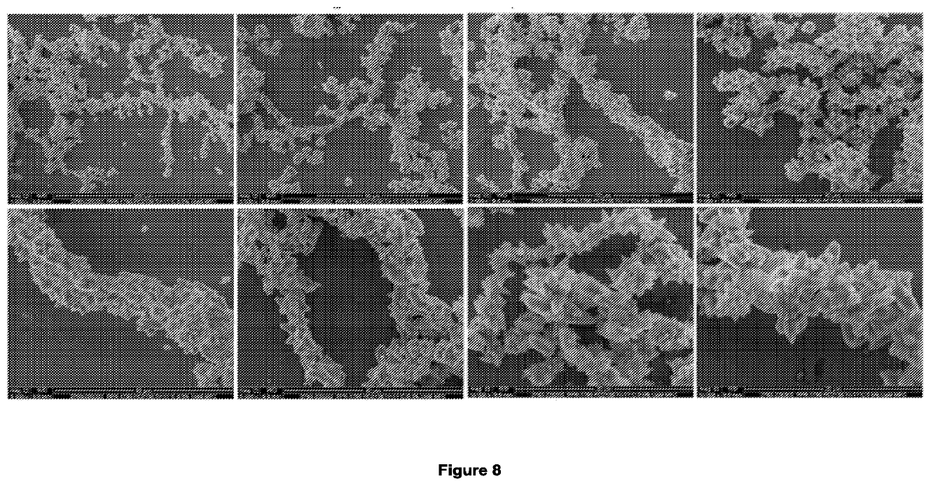

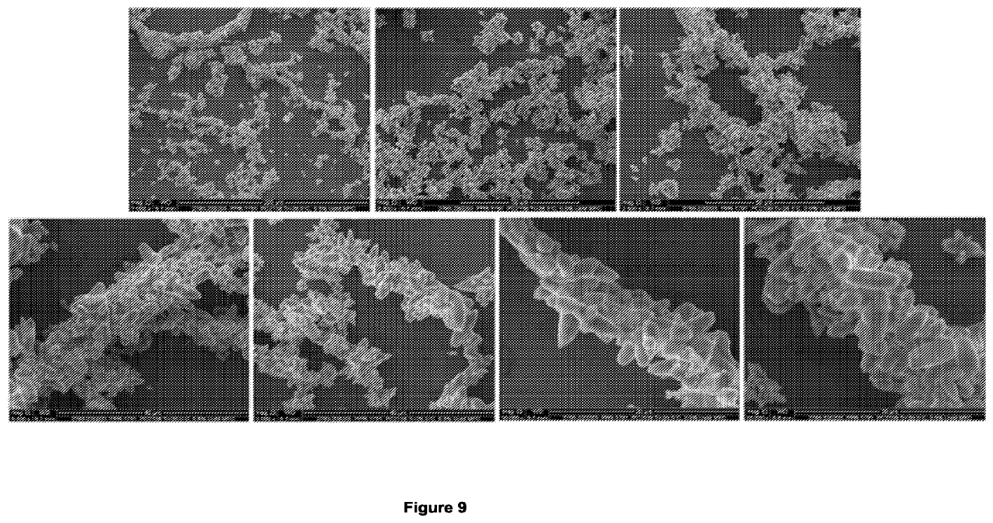

FIG. 6 is an SEM image of the precipitated calcium carbonate without fiber. FIGS. 7-9 includes SEM images of the composite fibers produced in accordance with the disclosure using 50% saturation at different starting aqueous heat temperatures. The resulting composite fibers had precipitated calcium carbonate morphologies that were predominately a mixture of scalenohedral and prismatic calcite. A starting temperature of 11° C. resulted in a smaller, narrower particle size distribution and a slightly higher surface area compared to using higher heel starting temperatures.

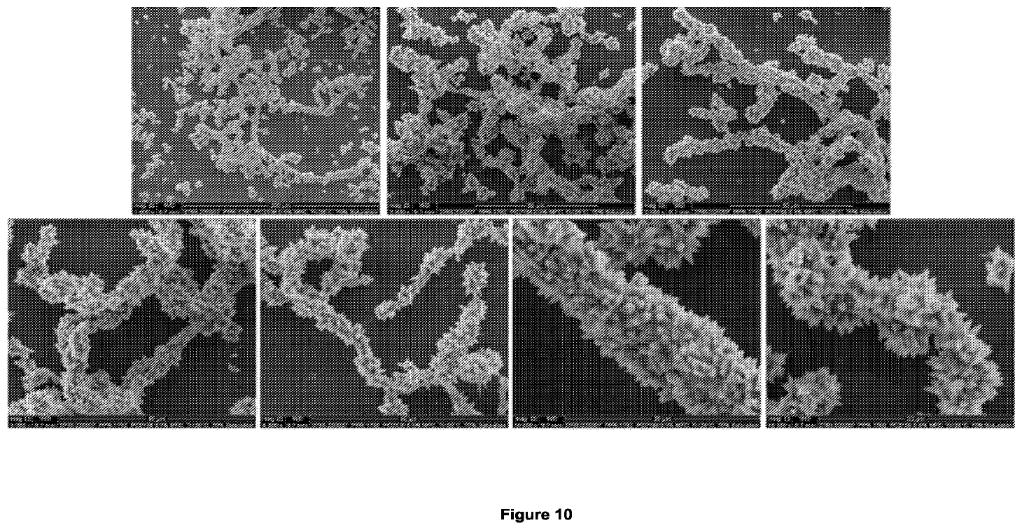

FIG. 10 includes SEM images of the composite fibers produced at 70% saturation. The resulting composite fiber has a much narrower particle size distribution, higher surface area and more scalenohedral morphology compared to the products made at 50% saturation.

### Aspects

Aspect 1. A filler comprising composite fibers, each composite fiber comprising mineral attached to a fiber, wherein the mineral is at least about 90 wt % based on the total weight of the composite fiber, the uncoated fiber has an average length of less than 300 μm, and the composite fiber has a Horiba d90 of at least 10 μm.
Aspect 2. The filler of aspect 1, wherein the mineral is calcium carbonate and the fiber is nanocellulose.
Aspect 3. The filler of aspect 1 or 2, wherein the composite fiber has a Horiba doo of at least 20 μm.
Aspect 4. The filler of any one of aspects 1 to 3, wherein the fiber is present in an amount of about 0.1 wt % to about 10 wt % based on the total weight of the composite fiber.
Aspect 5. The filler of any one of aspects 1 to 4, wherein the fiber has an average length of 100 μm to less than 300 μm.
Aspect 6. The filler of aspect 5, wherein the fiber has an average length of about 200 μm.
Aspect 7. The filler of any one of aspects 1 to 6, wherein the fiber is nanocellulose.
Aspect 8. The filler of any one of aspects 1 to 7, wherein the mineral has a scalenohedral morphology.
Aspect 9. A method of making composite fibers, comprising:
preparing a calcium hydroxide slake by diluting lime in water;
admixing an aqueous fiber slurry with dilution water in a reactor;
adding the calcium hydroxide slake and a CO₂ containing gas into the reactor containing the aqueous fiber slurry admixed with the dilution water to precipitate calcium carbonate onto the fiber; and
continuing a flow of the CO₂ containing gas into the admixture after the addition of the calcium hydroxide slake has started until a pH of 7.0 is reached, wherein:
the calcium hydroxide slake is added at a rate to maintain a target conductivity that is 50% to 80% of saturation and the target conductivity is maintained until the addition of the calcium hydroxide slake is complete,
the fiber slurry comprises fibers having a length of 300 μm or less, and
the fiber slurry comprises an amount of fiber such that fiber content in the composite fibers is 10 wt % or less based on the total weight of the composite fibers.
Aspect 10. The method of aspect 9, wherein the calcium carbonate has a scalenohedral morphology.
Aspect 11. The method of aspect 9 or 10, wherein addition of the calcium hydroxide slake is started before starting the addition of the gas comprising carbon dioxide.
Aspect 12. The method of aspect 9 or 10, wherein the addition of calcium hydroxide slake is started after starting the addition of the gas comprising carbon dioxide.
Aspect 13. The method of any one of aspect 9 to 12, wherein the aqueous fiber slurry is mixed while adding the calcium hydroxide slake and the gas comprising carbon dioxide.
Aspect 14. The method of any one of aspects 9 to 13, wherein the aqueous fiber slurry has a solids content of about 0.1% to 3% solids.
Aspect 15. The method of aspect 14, wherein the aqueous fiber slurry has a solids content of less than about 1%.
Aspect 16. The method of any one of aspects 9 to 15, wherein the calcium hydroxide slake comprises water and lime in a mass ratio of about 4:1 to about 15:1.
Aspect 17. The method of any one of aspect 9 to 16, wherein the calcium hydroxide slake is screened through a mesh screen having a 40 mesh to 200 mesh size prior to addition to the aqueous fiber slurry.
Aspect 18. The method of any one aspects 9 to 17, wherein the calcium hydroxide is added at a rate to maintain a conductivity that is about 50% to about 70% of saturation.
Aspect 19. The method of any one aspects 9 to 18, wherein the target conductivity is reached and maintained after 1% or less of completion of the reaction.
Aspect 20. The method of any one of aspects 9 to 19, wherein the gas comprising carbon dioxide comprises about 5% to about 100% carbon dioxide.
Aspect 21. The method of any one of aspects 9 to 20, wherein the fiber is nanocellulose.

Modifications and other embodiments disclosed herein will come to mind to one skilled in the art to which the disclosed compositions and methods pertain having the benefit of the teachings presented in the foregoing descriptions. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation.

It is also to be understood that the terminology used herein is for the purpose of describing particular aspects only and is not intended to be limiting. As used in the specification and in the claims, the term “comprising” can include the aspect of “consisting of.” Unless defined otherwise, all technical and scientific terms used herein have the same meaning as commonly understood by one of ordinary skill in the art to which the disclosed compositions and methods belong. In this specification and in the claims which follow, reference will be made to a number of terms which shall be defined herein.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

The use of the terms “a,” “an,” “the,” and similar referents in the context of the disclosure herein (especially in the context of the claims) are to be construed to cover both the singular and the plural, unless otherwise indicated. Recitation of ranges of values herein merely are intended to serve as a shorthand method of referring individually to each separate value falling within the range, unless otherwise indicated herein, and each separate value is incorporated into the specification as if it were individually recited herein. The use of any and all examples, or exemplary language (e.g., “such as”) provided herein, is intended to better illustrate the disclosure herein and is not a limitation on the scope of the disclosure herein unless otherwise indicated. No language in the specification should be construed as indicating any non-claimed element as essential to the practice of the disclosure herein.

1. A filler comprising composite fibers, each composite fiber comprising mineral attached to a fiber, wherein the mineral is at least about 90 wt % based on the total weight of the composite fiber, the uncoated fiber has an average length of less than 300 μm, and the composite fiber has a Horiba d90 of at least 10 μm.

2. The filler of claim 1, wherein the mineral is calcium carbonate and the fiber is nanocellulose.

3. The filler of claim 1, wherein the composite fiber has a Horiba doo of at least 20 μm.

4. The filler of claim 1, wherein the fiber is present in an amount of about 0.1 wt % to about 10 wt % based on the total weight of the composite fiber.

5. The filler of claim 1, wherein the fiber has an average length of 100 μm to less than 300 μm.

6. The filler of claim 5, wherein the fiber has an average length of about 200 μm.

7. The filler of claim 1, wherein the fiber is nanocellulose.

8. The filler of claim 1, wherein the mineral has a scalenohedral morphology.

9. A method of making composite fibers, comprising:
preparing a calcium hydroxide slake by diluting lime in water;
admixing an aqueous fiber slurry with dilution water in a reactor;
adding the calcium hydroxide slake and a CO₂ containing gas into the reactor containing the aqueous fiber slurry admixed with the dilution water to precipitate calcium carbonate onto the fiber; and
continuing a flow of the CO₂ containing gas into the admixture after the addition of the calcium hydroxide slake has started until a pH of 7.0 is reached, wherein:
the calcium hydroxide slake is added at a rate to maintain a target conductivity that is 50% to 80% of saturation and the target conductivity is maintained until the addition of the calcium hydroxide slake is complete,
the fiber slurry comprises fibers having a length of 300 μm or less, and
the fiber slurry comprises an amount of fiber such that fiber content in the composite fibers is 10 wt % or less based on the total weight of the composite fibers.

10. The method of claim 9, wherein the calcium carbonate has a scalenohedral morphology.

11. The method of claim 9, wherein addition of the calcium hydroxide slake is started before starting the addition of the gas comprising carbon dioxide.

12. The method of claim 9, wherein the addition of calcium hydroxide slake is started after starting the addition of the gas comprising carbon dioxide.

13. The method of claim 9, wherein the aqueous fiber slurry is mixed while adding the calcium hydroxide slake and the gas comprising carbon dioxide.

14. The method of claim 9, wherein the aqueous fiber slurry has a solids content of about 0.1% to 3% solids.

15. The method of claim 14, wherein the aqueous fiber slurry has a solids content of less than about 1%.

16. The method of claim 9, wherein the calcium hydroxide slake comprises water and lime in a mass ratio of about 4:1 to about 15:1.

17. The method of claim 9, wherein the calcium hydroxide slake is screened through a mesh screen having a 40 mesh to 200 mesh size prior to addition to the aqueous fiber slurry.

18. The method of claim 9, wherein the calcium hydroxide is added at a rate to maintain a conductivity that is about 50% to about 70% of saturation.

19. The method of claim 9, wherein the target conductivity is reached and maintained after 1% or less of completion of the reaction.

20. The method of claim 9, wherein the gas comprising carbon dioxide comprises about 5% to about 100% carbon dioxide.

21. The method of claim 9, wherein the fiber is nanocellulose.
